(19) United States
(12) Patent Application Publication
(10) Pub. No.: US 2018/0220775 A1
(43) Pub. Date: Aug. 9, 2018

(54) Work Holder for Hair Tension

(71) Applicant: Ryan Tokko, Los Angeles, CA (US)

(72) Inventor: Ryan Tokko, Los Angeles, CA (US)

(21) Appl. No.: 15/882,563

(22) Filed: Jan. 29, 2018

Related U.S. Application Data
(63) Continuation-in-part of application No. 29/613,254, filed on Aug. 8, 2017.
Application No. 29/613,254 is a continuation-in-part of application No. 29/627,029, filed on Nov. 21, 2017.
(60) Provisional application No. 62/451,576, filed on Jan. 27, 2017.

(51) Int. Cl. A45D 44/00; F16B 47/00; F16M 13/02

(52) U.S. Cl. CPC A45D 44/00; A41G 5/004; F16M 13/022; F16B 47/006

(57) ABSTRACT

A work holder for hair extension includes a bracket adapted to hold an extension hair piece, a body to which the bracket is detachably assembled and an attaching device that is adapted to attach the body to a flat surface. The bracket includes a plurality of comb bristle rods, each of which includes an elongated vertical bar having a predetermined length, a horizontal bar extending from the vertical bar and having a predetermined width, and a stop bar extending from the horizontal bar and having a predetermined height.

### CROSS-REFERENCE TO RELATED APPLICATIONS

This application claims priority on the inventor's Provisional Application No. 62/451,576 filed on Jan. 27, 2017, Design patent application Ser. No. 29/613,254 filed on Aug. 8, 2017 and Design patent application Ser. No. 29/627,029 filed on Nov. 21, 2017, the disclosures of which are incorporated by reference.

### BACKGROUND OF THE INVENTION

### 1. Field of the invention

The present invention is related to a work holder for hair extension. More particularly, the present invention is related to a work holder for hair extension that simplifies of work of handling and storing hair extensions.

### 2. Discussion of Related Technology

Generally, the hair extension technology connects one or more extension hair pieces to hair of a person or an animal. The extension hair pieces are to make the person/animal's hair look longer or thicker and/or add color accents to the person/animal's hair. The extension hair pieces for hair extension are in various forms and shapes, and include hair weaves, widgets, etc. In order to attach hair extension to customer's natural hair, various methods using metal tubes, double-sided tape, hair pins have been used. Extension hair pieces are expensive, and the handling, storing and organizing of the extension hair pieces require a lot of care. A work holder for hair extension that facilitates such work has long been in need. The foregoing discussion in this section is to provide general background information, and does not constitute an admission of prior art.

### SUMMARY OF THE INVENTION

An objective of the invention is to provide a work holder for hair extension, which simplifies the work of the handling, storing and maintaining of the extension hair pieces.

In order to achieve the objective, the present invention provides work holder for hair extension comprising a bracket adapted to hold an extension hair piece; a body to which the bracket is detachably assembled; and an attaching device that is adapted to attach the body to a flat surface. The bracket comprises a plurality of comb bristle rods, each of which comprises an elongated vertical bar having a predetermined length, a horizontal bar extending from the vertical bar and having a predetermined width, and a stop bar extending from the horizontal bar and having a predetermined height.

The attaching device comprises a suction cup and a rotating button that enables release of the suction cup and disassembly of the bracket.

The body comprises a groove. The bracket further comprises a cross bar to which the plurality of comb bristled rods are fixed. The cross bar is received in the groove.

The rotating button covers and blocks the groove whereby the cross bar is secured in the groove.

Preferably, the number of comb bristle rods is in a range from five (5) through fifty (50).

Preferably, the width of the bracket is in a range from five (5) cm through ten (10) cm.

Preferably, the height of the bracket is in a range from three (3) cm through seven (7) cm.

The advantageous effects of the present invention are: (1) the holder facilitates maintaining an extension hair piece (shampoo, dry, style; (2) up to several extension hair pieces can be stored in one holder: (3) the holder can easily be attached to and detached from any flat surface; (4) the holder stores extension hair pieces in suspended state so that the hair strands stay straight; (5) the extension held by the holder is visible in a wide range of angle and (6) a modular device that can be used as many as needed, can quickly and conveniently installed in user's space.

### BRIEF DESCRIPTION OF THE DRAWINGS

The accompanying drawings illustrate the best embodiments of the present invention. In the drawings:

FIG. 1 is a top plan view of a work holder for hair extension showing a first embodiment;

FIG. 2 is a bottom plan view thereof;

FIG. 3 is a right side-elevation view thereof;

FIG. 4 is a left side-elevation view thereof;

FIG. 5 is a front elevation view thereof;

FIG. 6 is a rear elevation view there of;

FIG. 7 is a perspective view thereof;

FIG. 8 is a top plan view of a work holder for hair extension showing a second embodiment;

FIG. 9 is a bottom plan view thereof;

FIG. 10 is a right side-elevation view thereof;

FIG. 11 is a left side-elevation view thereof;

FIG. 12 is a front elevation view thereof;

FIG. 13 is a rear elevation view there of;

FIG. 14 is a perspective view thereof;

FIGS. 15 and 16 are partial perspective views showing a body and a bracket before assembly;

FIG. 17 is a perspective view showing the body and the bracket assembled;

FIG. 18 is a perspective view showing an extension hair piece is held on the bracket; and

FIG. 19 is a cross-sectional view showing an attaching device.

### DESCRIPTION OF PREFERRED EMBODIMENTS

Embodiments will be described in detail below. The accompanying drawings will be used for describing embodiments. For the sake of convenience of illustrating embodiments, thickness, length, diameter, size and other dimensions of components and/or hair would be illustrated or exaggerated to be different with, those of actual components and/or hair, and the subject matter of this application is not limited to the illustrated embodiments.

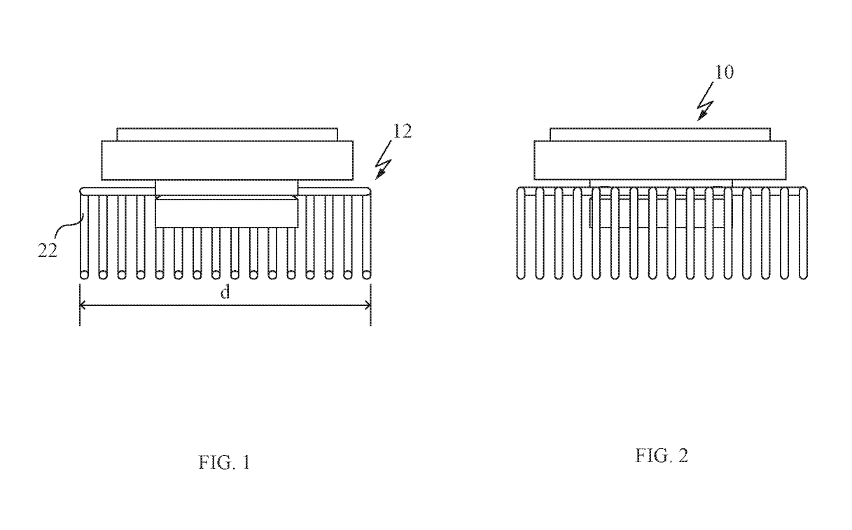

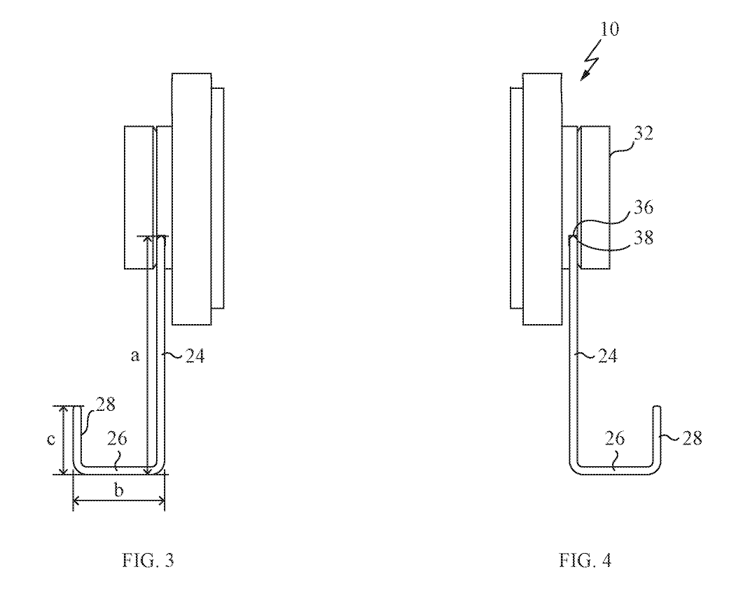

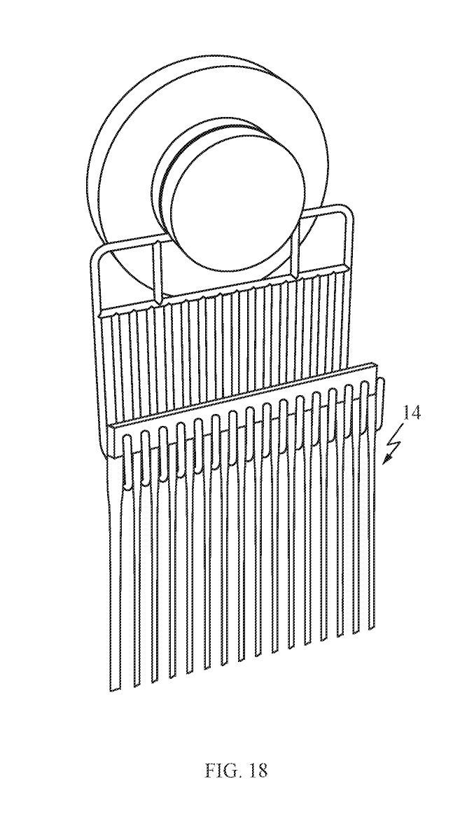

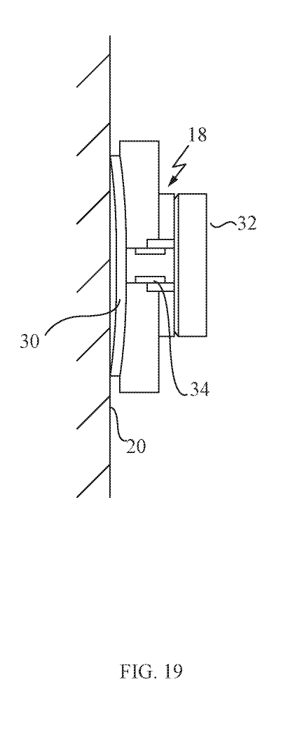

FIGS. 1-8 show a first embodiment. Referring to FIG. 7, a work holder for hair extension 10 comprising a bracket 12 adapted to hold an extension hair piece 14 (refer to FIG. 18); a body 16 to which the bracket 12 is detachably assembled; and an attaching device 18 that is adapted to attach the body 16 to a flat surface 20 (refer to FIG. 19). Referring to FIGS. 1-4, the bracket 12 comprises a plurality of comb bristle rods 22, each of which comprises an elongated vertical bar 24 having a predetermined length a, a horizontal bar 26 extending from the vertical bar 24 and having a predetermined width b, and a stop bar 28 extending from the horizontal bar 26 and having a predetermined height c.

Referring to FIG. 19, the attaching device 18 comprises a suction cup 30 and a rotating button 32 that enables release of the suction cup 30 via thread engagement 34 and disassembly of the bracket 12.

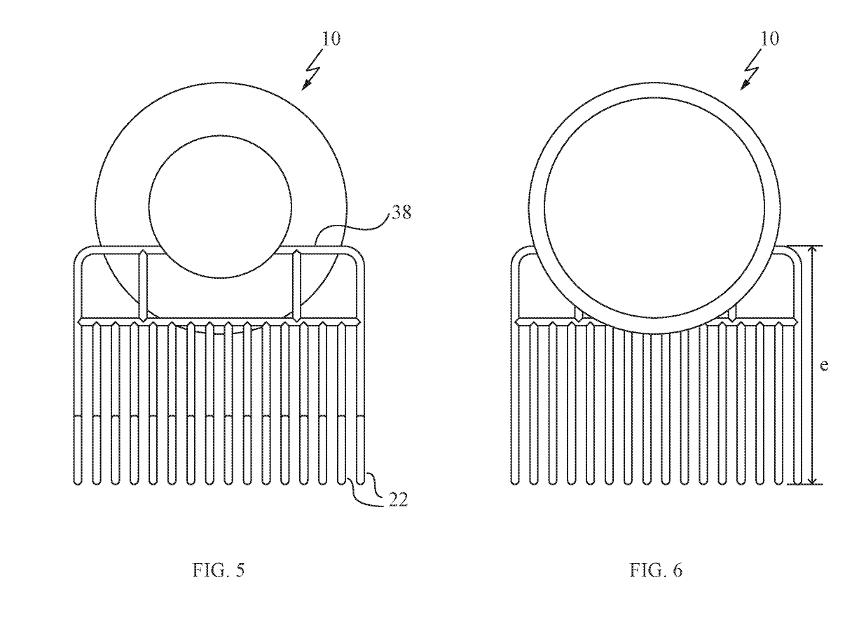

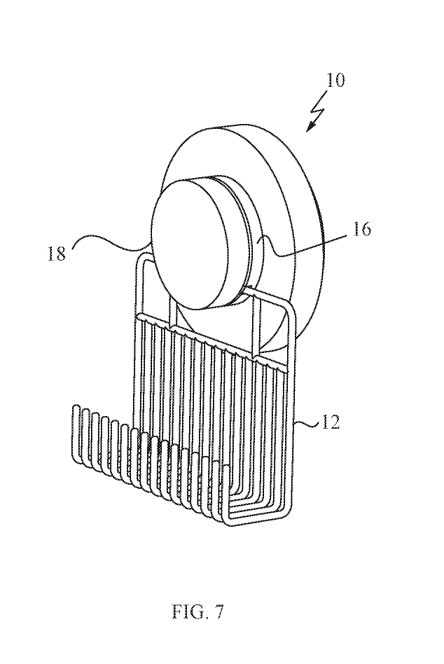

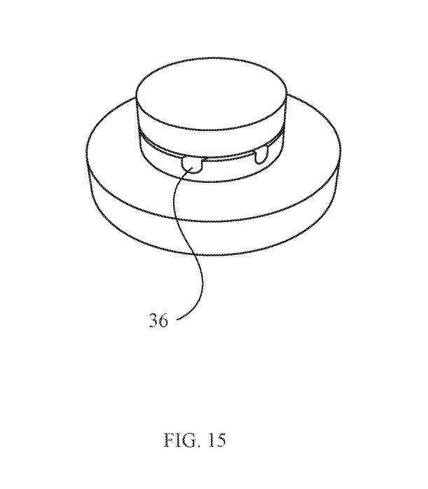

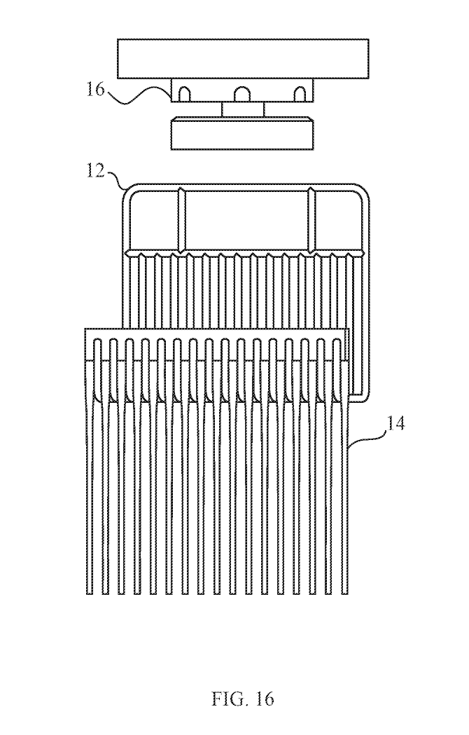

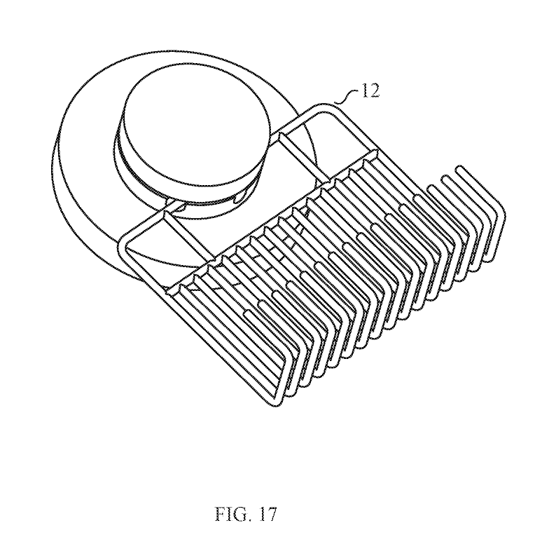

The body comprises a groove 36 (Refer to FIG. 15). The bracket 12 further comprises a cross bar 38 (Refer to FIG. 5) to which the plurality of comb bristled rods 22 are fixed. Referring to FIG. 4, the cross bar 38 is received in the groove 36. When engaged, the rotating button 32 covers and blocks the groove 36 whereby the cross bar 38 is secured in the groove 36.

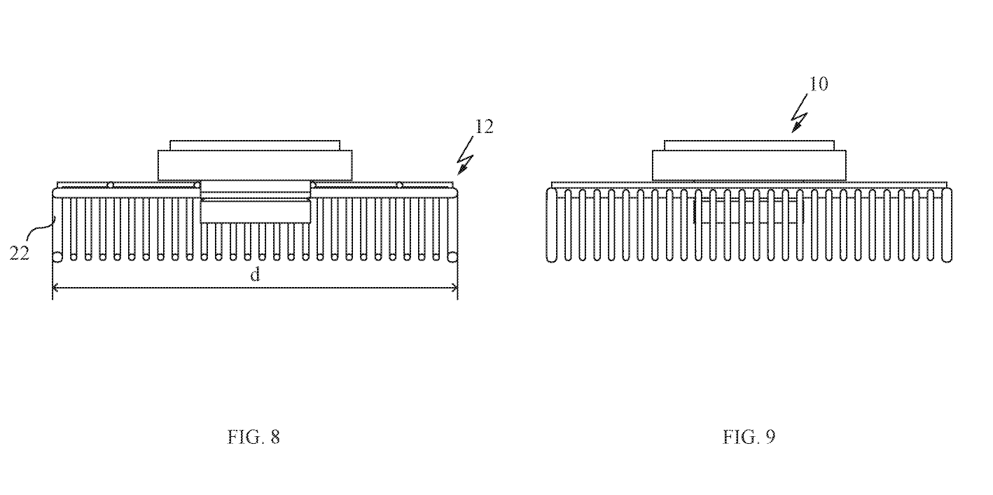

Preferably, the number of comb bristle rods 22 is in a range from five (5) through fifty (50). Preferably, the width d of the bracket (refer to FIG. 1) is in a range from five (5) cm through ten (10) cm. Preferably, the height e of the bracket (refer to FIG. 6) is in a range from three (3) cm through seven (7) cm.

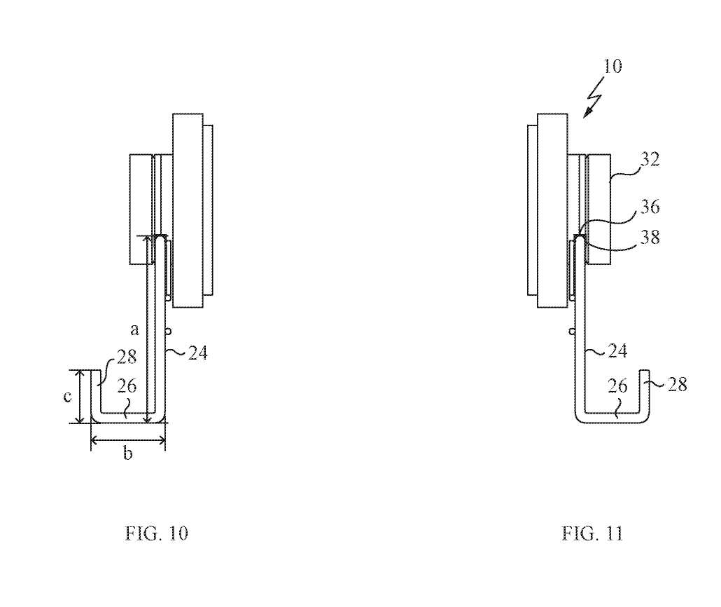

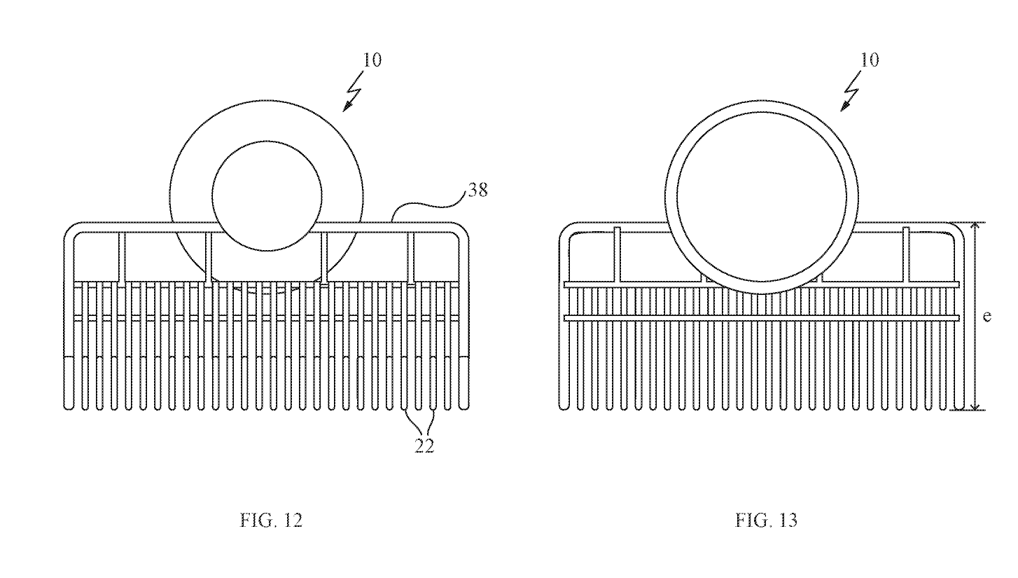

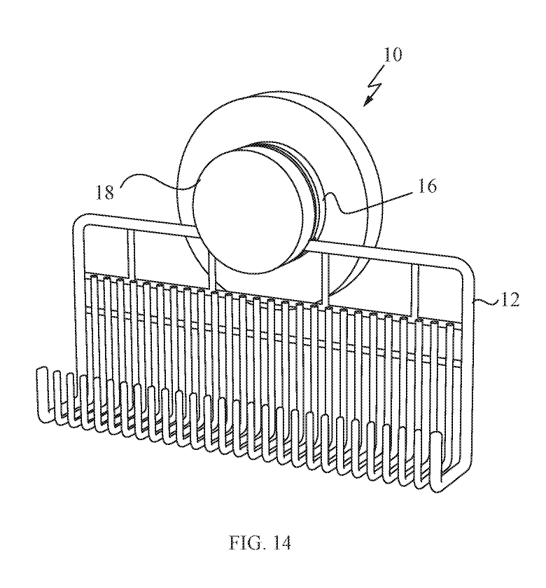

FIGS. 8-14 show a second embodiment of the work holder 10, which includes different number and size of the comb bristle rod 22.

The comb bristle rod 22 forms a comb part that is adapted to support the extension hair piece 14. The horizontal bar 26 forms an anchor part that prevents falling of the extension hair piece and provides a gap to hold the plurality (usually up to seven) of the spring pins for one hair extension. The stop bar forms a latch part that covers the comb part whereby the upper part (band) of the hair extension is held inbetween. Number of comb bristle and the various dimensions (a, b, c, d, e) are determined to accommodate various types of hair extensions. The suction cup facilitates attaching the holder to a smooth surface nearby a working space for a user or stylist.

Although the hair extension holder according to an exemplary embodiment of the present invention has been described in detail hereinabove, it should be understood that many variations and modifications of the basic inventive concept herein described, which may appear to those skilled in the art, will still fall within the spirit and scope of the exemplary embodiments of the present invention as defined by the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

1. A work holder for hair extension comprising:
a) a bracket adapted to hold an extension hair piece;
b) a body to which the bracket is detachably assembled; and
c) an attaching device that is adapted to attach the body to a flat surface;
wherein the bracket comprises a plurality of comb bristle rods,
wherein each of the comb bristle rods comprises:
(i) an elongated vertical bar having a predetermined length,
(ii) a horizontal bar extending from the vertical bar and having a predetermined width, and
(iii) a stop bar extending from the horizontal bar and having a predetermined height.

2. The work holder for hair extension of claim 1, wherein the attaching device comprises a suction cup.

3. The work holder for hair extension of claim 2, wherein the attaching device further comprises rotating button that enables release of the suction cup.

4. The work holder for hair extension of claim 2, wherein the rotating button enables disassembly of the bracket.

5. The work holder for hair extension of claim 4, wherein the body comprises a groove, wherein the bracket further comprises a cross bar to which the plurality of comb bristled rods are fixed, wherein the cross bar is received in the groove.

6. The work holder for hair extension of claim 5, wherein the rotating button covers and blocks the groove whereby the cross bar is secured in the groove.

7. The work holder for hair extension of claim 6, wherein the number of comb bristle rods is in a range from five (5) through fifty (50).

8. The work holder for hair extension of claim 7, wherein the width of the bracket is in a range from five (5) cm through ten (10) cm.

9. The work holder for hair extension of claim 8, wherein the height of the bracket is in a range from three (3) cm through seven (7) cm.

10. The work holder for hair extension of claim 9, wherein the elongated vertical bar, the horizontal bar and the stop bar form a hook.
